(19) United States
(12) Patent Application Publication
(10) Pub. No.: US 2025/0086900 A1
(43) Pub. Date: Mar. 13, 2025

(54) System, and Method for Augmenting Reality with Authenticated, Digital Assets Via Predefined, Physical Assets

(71) Applicants: Christopher Leonardo Price, San Francisco, CA (US); Rocky Mudaliar, Blind Bay (CA); Dominic Bilodeau, Irvine, CA (US); Xiao-Long Chang, Irvine, CA (US)

(72) Inventors: Christopher Leonardo Price, San Francisco, CA (US); Rocky Mudaliar, Blind Bay (CA); Dominic Bilodeau, Irvine, CA (US); Xiao-Long Chang, Irvine, CA (US)

(21) Appl. No.: 18/462,908

(22) Filed: Sep. 7, 2023

(51) Int. Cl. G06T 19/00

(52) U.S. Cl. CPC G06T 19/006

(57) ABSTRACT

A physical asset, such as an item of clothing or a wearable accessory, is embedded with a paired transmitter and receiver that defines the physical asset's actual position, size, orientation, and shape. An electronic device, equipped with the same, or otherwise operative to communicate with such transmitter/receiver, comprises a display and is operative to receive sensor feedback as well as location and orientation information as determined from the physical asset's actual position, size, orientation, and shape and communicated by the transmitter/receiver. A digital asset, configured as non-fungible tokens whose ownership is recorded on the blockchain, may be visually mapped to the physical asset and appear, via the electronic device display, to overlay the physical asset. In some embodiments, a digital asset may additionally or alternatively be visually mapped to any of the environment surrounding the physical asset and thus appear to overlay or augment such environment.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to the augmentation of reality and, more particularly, to systems and methods for visually overlaying, or otherwise attaching or assigning various digital assets, including authenticated non-fungible tokens, to or around physical objects and avoiding the use of cameras to do so.

### BACKGROUND

Virtual and augmented reality experiences are increasingly accessible to the masses with thanks to dramatic improvements in overall computing power, graphic processing capabilities, and computer modeling techniques. As a method for superimposing computer-generated images on individual-users' own view of the world around them, augmented reality, in particular, has been popular for enriching or otherwise informing video game play, online and in-person shopping, apparent bodily transformation, self-expression, electronic communications, and virtual interaction in general, to name a few. This is at least in part because of the opportunities augmented and virtual reality offers to impermanently deliver novel experiences and aid personalization and customization in a variety of settings.

In many contexts, the execution and delivery of augmented reality experiences in particular relies on cameras to capture a real-world mark or target to be digitally altered along with its surrounding environment. For instance, the following references make use of cameras specifically for augmenting reality. U.S. Pat. Pub. No. 2012/0319949 by Moon Key Lee utilizes multiple cameras to capture images for augmented reality and for determining relative positioning of a mark to be augmented. U.S. Pat. No. 9,317,962 to Morato et al. teaches rendering three-dimensional spaces with two-dimensional content in which a user's position is determined by a camera-enabled visual positioning system. U.S. Pat. No. 10,176,636 to Neustein et al. teaches augmenting an image of a person with virtual clothing by way of a camera configured to capture image data. In an increasingly digital age, concerns over privacy and the accessibility and even permanence of one's own digital legacy abound, though. In particular, many are concerned about the others' cameras being used to record them and capture their data, with no knowledge or control over the ultimate fate of such data.

Thus, although various proposals have been made to make certain digital experiences more widely available and even adaptable, none of those in existence combine the characteristics of the present invention. Therefore, there remains a need for systems and methods that enable augmented reality without the use of cameras.

### SUMMARY

The present disclosure is directed to a system for augmenting reality in a manner that avoids reliance on cameras. Namely, certain real-world, physical assets are configured as marks—or targets—for digital augmentation and are equipped with a transmitter and receiver operative communicate the size, shape, location, and even orientation of each such physical asset to a user electronic device equipped with a corresponding transmitter and receiver and display.

Data characterizing the size, shape, contours, outline, and the like, as spatial parameters of the physical asset may be predefined and related to the actual, real-world spatial parameters that define the shape and appearance of the physical asset. However, it is contemplated that data characterizing the location and orientation of the physical asset will be dynamic and depend on the location and orientation of the physical asset relative to the user electronic device. Based on the physical asset spatial parameters and dynamic location and orientation data, the user electronic device is operative to digitally overlay a digital asset on or around the physical asset at the display to provide a digitally augmented view of reality to the user.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In an embodiment, the physical asset may be any real-world object, such as an item of clothing, accessory, device, structure, or any other real-world object as desired or needed, embedded with a transmitter/receiver pair as, for example, a chip, that defines the physical asset's actual size, shape, contours, outline, and the like as spatial parameters noted above. A user electronic device, equipped with a transmitter/receiver operative to communicate with such chip, comprises a display and is operative to receive sensor feedback as well as the spatial parameters of the physical asset and location and orientation information determined from the physical asset's location and orientation relative to the electronic device, as communicated by the respective transmitter/receivers. A digital asset, such as a digitally-rendered item of clothing or accessory, or any other digitally-rendered element, design, item, device, digital object, or token alike may be visually mapped to the physical asset and appear, via the electronic device display, to overlay the physical asset. In some embodiments, a digital asset may additionally or alternatively be visually mapped to any of the environment surrounding the physical asset and thus appear to overlay, additionally or alternatively, such environment.

In some embodiments, the chip is any computing chip configured to precisely locate and communicate with other chips or devices that support corresponding communication protocols. For instance, such computing chip may utilize ultra-wideband (“UWB”) technology to locate and transmit the location, orientation, and spatial parameters of equipped physical assets relative to a user electronic device equipped with another UWB chip. In general, UWB use of high frequency, low range radio signals, and time-of-flight system configured to measure the distance between a sensor, such as a sensor in the user electronic device, and an object, such as the physical asset, enable the user electronic device to accurately locate the physical asset. In practice, this allows precise, location-aware communication between the physical asset chip and user electronic device.

It is contemplated that the invention may utilize other wireless communication protocols, such as Wi-Fi and/or Bluetooth, among others known to those of ordinary skill in the art, however, UWB will be discussed throughout this disclosure for the sake of brevity and clarity without limiting the disclosure.

In some embodiments, providing corresponding chips in this manner may improve spatial awareness in a system over methods that previously relied on the use of cameras and assigning or ascertaining three-dimensional meshes from targeted meshes. Because wireless chips, like UWB chips discussed herein, can understand the location, orientation, and spatial parameters of the physical asset relative to an electronic device equipped with a corresponding chip, the system may be configured to visually accurately overlay a digital asset assigned to that chip, and apparently accurately, visually displayed to a user. In practice, for example, when the physical asset is rotated or otherwise moved in a real-world space relative to a user's chip and display equipped-electronic device, the user's display would show the corresponding digital asset rotating or turning accordingly. It will be appreciated that utilizing chips in this manner to predefine physical asset spatial parameters and communicate those spatial parameters avoids any need to rely on cameras or traditional machine learning models to digitally reflect or show that the physical object is rotating or moving.

In some embodiments, the digital asset may be a non-fungible token (NFT) immutably tracked on a digitally distributed ledger such as a blockchain. In such embodiments, it is contemplated that each authorized user may be granted access to a digital asset distributor's private key, known to those of ordinary skill in the art, and discussed in further detail below. In short, authorization and access may be recorded on an existing distributer and viewer or user digital wallet, known to those of ordinary skill in the art, in order to restrict access to and authenticate ownership and source of digital assets.

It is contemplated that enabling augmented reality according to the disclosure and claims provided below may preserve privacy for those that may be captured as marks or targets for augmented reality. In addition, enabling augmented reality in this manner may protect the exclusivity, ownership, and other commercial interests in digital assets.

It is an object of the invention to digitally augment real-world items and/or scenery.

It is another object of the invention to reduce reliance on real-world props and sets to enhance visual performances.

Thus, it is an object of the invention to avoid reliance on cameras to enable augmented reality.

It is another object of the invention to augment reality with digital assets immutably tracked on a distributed ledger.

It is yet another object of the invention to securely restrict access to digital assets to verified owners or licensors of the digital asset(s).

It is still another object of the invention to simultaneously augment reality for multiple users or viewers such that each user's individual perspective of a physical asset, via his or her own respective electronic device, are accurately overlayed by digital asset(s) in terms of location and orientation relative to each respective user electronic device.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIGS. 1 and 2 show alternative exemplary augmented reality scenarios in accordance with certain embodiments of the invention.

FIG. 3 is a block diagram of a networked environment in which an exemplary embodiment of a system for augmenting reality with authenticated, digital assets via predefined, physical assets is implemented.

FIG. 4 illustrates an exemplary embodiment of a user electronic device shown in FIG. 3.

FIG. 5 illustrates an exemplary embodiment of a computing device shown in FIG. 3.

FIGS. 6A-C is a series of flowcharts illustrating an exemplary embodiment of a method augmenting reality with authenticated, digital assets via predefined, physical assets.

FIG. 7 is yet another exemplary augmented reality scenario in accordance with one embodiment of the invention.

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

The present invention, in some embodiments, may comprise a decentralized electronic database distributed across various computers, or “nodes.” Full, lightweight (or simply “light”) nodes, client and submitting-client, peer, endorser, orderer, and/or ordering-service nodes are collectively referred to herein as “nodes” unless otherwise specified. The decentralized database may securely store and transmit data between computers, other electronic devices, and/or one or more nodes. The present invention may provide that when a new data record, such as a transaction, is created, it may link to the user's previous data record in the manner known in the block chain database art by using the storage information and chain-creation logarithms or instructions within the data record. By way of non-limiting example, the “genesis” block of a particular blockchain may contain a hash comprising its time and date of creation, at least one element of data (content, usage, rights data or cryptocurrency ownership) and a computer-solvable problem that, when solved, allows another block to link to the present block. Similarly, all other blocks on the blockchain in question may then comprise the previous block's hash, a hash comprising that block's time and date of creation, at least one element of data (content, usage, rights data or cryptocurrency ownership) and a computer-solvable problem that, when solved, allows another block to link to the present block.

In some embodiments, the present invention contemplates a separate blockchain for a cryptocurrency ledger that records cryptocurrency transfers and ownership data, content of all types (thereby ensuring the content's integrity), and content usage by users. In some embodiments, the present invention may process data from one type of blockchain (i.e. usage) and cause a change in one or more other blockchains (i.e. may record a related cryptocurrency transfer on the cryptocurrency ledger blockchain). In some embodiments, any blockchain may comprise any combination of data types. For example, a digital rights management tool may comprise a blockchain containing content, usage, and rights data within the data blocks. Or, in some embodiments, the digital rights management tool may comprise three separate blockchains for content, usage, and rights data. In some embodiments, the present invention may utilize one or more digital rights management tools and one or more cryptocurrency systems and ledgers in tandem or in combination.

By creating a linked series of immutable data records, the present invention may provide a secure chain of data records. As discussed more fully herein, the chain information may comprise one or more cryptographic hashes. For example, if the second data record contains the first data record's hash, the link between the two may be verified. By creating a new hash for each data record, and including that hash in the second data record, the present invention may provide for a traceable chain of data records.

The present invention may use real-world objects such as data matrix codes (or quick response “QR” codes) as private keys that “unlock” or decrypt a set of data when a user scans the QR code. A non-limiting application of this may be a physical “wallet” bearing a QR code that corresponds to a user's cryptocurrency account.

In some embodiments, a node may be any suitable electronic device, such as but not limited to a server, a user electronic device, or desktop computer, that is linked to one or more networks provided by the present invention and that may perform the functions of the present invention, such as storing, linking block-to-block (“chaining” and thereby creating a link in a blockchain), encrypting, decrypting, and transmitting data. Each node may be configured to independently and automatically verify, update, link, and store each record.

The blockchain database of the present invention may utilize various cooperative or decentralized computing principles. In some embodiments, the blockchain database of the present invention may utilize principles or techniques drawn from cloud computing, thin-cloud computing, fog computing, or even “blockcloud” computing. The present invention may provide that the software, systems, methods, applications, computer programs, and so forth required to execute one or more instructions, methods, computer programs, or functions of the present invention may be stored on nodes, a cloud, thin cloud, fog, or blockcloud server structure.

The present invention may also provide for one or more interface elements, such as by way of illustration and not limitation, a desktop software program, a mobile application, or a website, that enables the user or, in some embodiments, a member of the public, to view one or more elements of a data record. By way of illustration and not limitation, a website may host an interface, wherein a login action could take a user to an individual's webpage. On the webpage, the present invention may describe or link to one or more elements of the individual's data record. By way of illustration and not limitation, such a page may contain a randomized identifier, the present data record's hash, a link to the data record's previous hash, and one or more links to one or more elements of user-specific data. In some embodiments, when viewed by a member of the general public, the webpage and the data record information may be hidden, randomized, or otherwise unreadable. Or in some embodiments, when viewed by a member of the general public, the webpage and the data record information may be deidentified but otherwise viewable. In some embodiments, when “unlocked” via the QR code, the data record may display unencrypted versions of the user-specific data, along with the hashes.

The present invention may comprise some elements of traditional block chain database encryption, storage, management, and access. The present invention may also make use of other, more widely-used technologies, such as cloud computing, emails, and text messages. The present invention may also draw upon, digitize, or otherwise incorporate paper documents in some embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

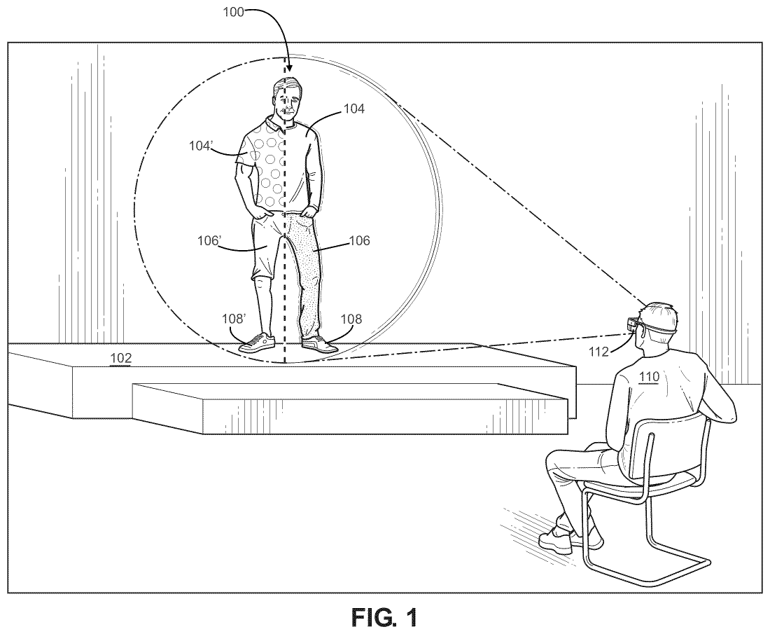

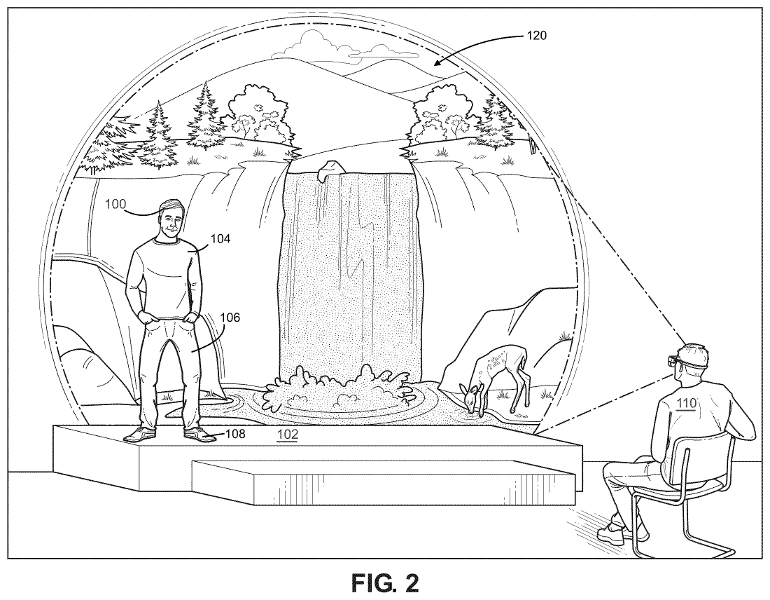

The system and method are configured to augment physical assets having pre-defined spatial parameters corresponding to their real-world spatial parameters with digital assets authenticated on a distributed ledger in a manner that avoids the use of a camera. For the sake of clarity, alternative, yet non-limiting, exemplary augmented reality scenarios are initially provided with reference to FIGS. 1 and 2 to contextualize the detailed description that follows. In FIG. 1, for instance, a performer 100 is shown on a stage 102 wearing a shirt 104, pants 106, and shoes 108 each defining an exemplary physical asset. Of course, one of ordinary skill in the art will recognize that any item of clothing, accessory, object, structure, device, or other real-world object, may define the physical asset. Each physical asset comprises at least one wireless transmitter and receiver, embedded in the physical asset and therefore not visible in FIG. 1, operative to transmit any size, shape, contours, outline, and the like as pre-defined spatial parameters of the physical asset. The transmitter and receiver may be embedded or otherwise incorporated into the physical asset in any number of ways as desired or needed. As one clarifying example, it may be sewn into the physical asset as a garment. It may be glued, taped, embedded, or otherwise incorporated into the physical asset as necessary.

In some embodiments, the spatial parameters may be used to more fully define a three-dimensional mesh of the physical asset. Such spatial parameters correspond to the real-world spatial parameters that characterize the actual size, shape, contours, outline, and the like that contribute to the appearance of the physical asset.

In the exemplary embodiment shown in FIG. 1, a viewer 110 is shown observing the performer 100 through a user electronic device such as, for example only and not limitation, augmented reality glasses 112. The user electronic device comprises control circuitry and a display as well as a transmitter and receiver operative to exchange communications signals with the at least one transmitter and receiver of the physical asset, determine spatial parameters of the physical asset, and determine the location and orientation of the user electronic device relative to the user electronic device.

The user electronic device is further operative to display a digital asset, which may be any digitally-rendered item of clothing or accessory, or any other digitally-rendered element, design, item, device, digital object, or token alike, on or around the physical asset. In other words, the system is configured to overlay a digital asset on some real-world physical asset or on the area surrounding the real-world physical asset. In the exemplary FIG. 1, a plurality of digital assets are provided, in accordance with one embodiment of the invention, and comprise digitally augmented versions of the performer's 100 shirt 104′, shorts 106′, and shoes 108′, which appear to the user, via his electronic device display, to overlay each corresponding physical asset 104, 106, 108. Of course, it will be understood that neither all of the physical assets, nor the entire portion of any physical asset, must be overlayed or surrounded to practice the invention. Partial augmentation by any digital asset of any real-world physical asset is explicitly within the scope of this disclosure.

FIG. 2 shows, in the alternative, a digital asset as a nature scene 120 comprising exemplary features such as a waterfall, deer, grass, and trees surrounding the performer 100 on an otherwise generic-looking stage 102. In such cases, spatial parameters of the physical assets, such as 104, 106, and 108, or any other physical asset as may be equipped according to the disclosure, may provide a boundary around which a digital asset may appear. That is, the digital asset may overlay any area surrounding a physical asset.

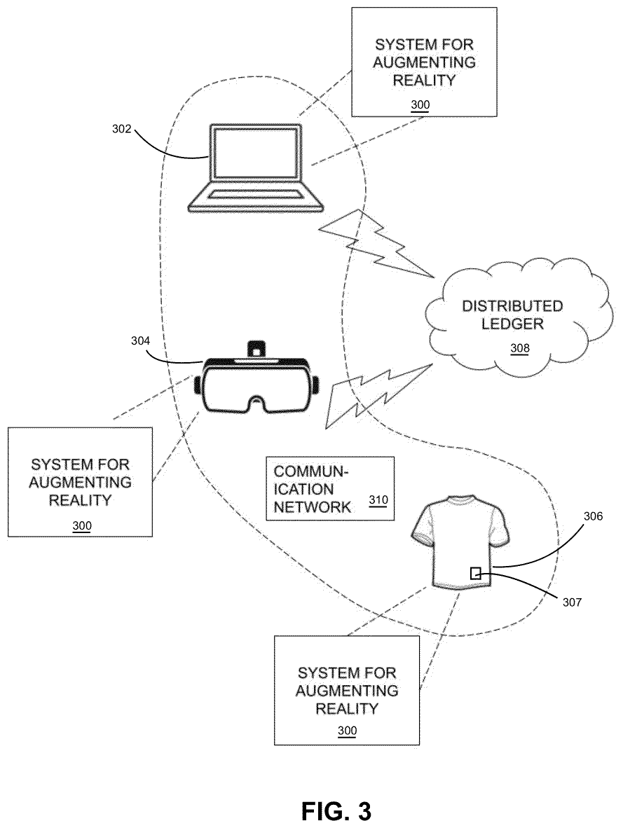

FIG. 3 is illustrative of an exemplary embodiment of a system and method for augmenting reality 300 which includes a plurality of electronic devices communicatively coupled to one another in a communication network 310. By way of example, and not limitation, FIG. 3 illustrates a first computing device associated with at least one distributer 302 and at least one second electronic device associated with one or more viewers 304, and a physical asset 306 equipped with a computing chip 307. A single chip 307 is shown in the figure, however it is contemplated that providing a plurality of chips 307 at various locations on the physical asset may avoid disruption to the communications between the physical asset and user electronic devices when external obstructions block one or more of the transmitter/receivers.

In an embodiment, the distributer may be the owner or licensor of a digital asset. Each of the first computing device 302, user electronic device 304, and physical asset 306 may be communicatively coupled via a communications network 310. In some embodiments, the computing device and viewer electronic device may additionally be communicatively linked on a distributed ledger 308. Although the user electronic device(s) is associated with an augmented reality headset or glasses within the disclosure, it is contemplated that the first computing device 302 and user electronic device 304 may be embodied as any computing device, for example and without limitation, a mobile computing device such as a smartphone or tablet computer that incorporate cellular telephone functionality, or a laptop computer or desktop computer.

Notably, the communications network 310 may use one or more of various communications types. In one embodiment, the various electronic devices comprising the system for augmenting reality 300 may comprise a computing chip defined by control circuitry having processing circuitry used to implement communications protocols for wireless communications between such electronic devices. Such computing chip may be configured to precisely locate and communicate with other chips or devices that support corresponding communication protocols. In one embodiment, the computing chip may utilize ultra-wideband (“UWB”) technology to locate and transmit the location, orientation, and spatial parameters of equipped physical assets, such as 306, relative to a user electronic device equipped with another UWB chip, such as 304. In general, UWB use of high frequency, low range radio signals, and time-of-flight system configured to measure the distance between a sensor, such as a sensor in the user electronic device 304, and an object, such as the physical asset 306, enable the user electronic device 304 to accurately locate the physical asset 306. In practice, this allows precise, location-aware communication between the physical asset 306 chip and user electronic device.

It is contemplated, however, that the communications network 310 may alternatively use, for example and without limitation, short range device-to-device wireless data transfer (i.e. Bluetooth), BLE, ZigBee, Z-Wave, 6LoWPAN, Thread, WiFi-ah (HaLow), 2G (GSM), 3G, 4G, LTE Cat 0, LTE Cat 1, LTE Cat 2, LTE Cat 3, LTE-MN1, NB-IoT, 5G, NFC, RFID, SigFox, LoRaWAN, Ingenu, Weightless-N, Weightless-P, Weightless-W, ANT & ANT+, DigiMesh, MiWi, EnOcean, Dash7, WirelessHART, and other network protocols, cellular, or Wi-Fi communications. In some embodiments, one or more nodes (not pictured) may take the place of one or more computing devices 302, 304. The communications network 310 may serve to communicatively couple, link, or transfer data between one or more of computing devices 302, 304 and any node with the distributed ledger 308.

Indeed, it is contemplated that any digital asset may be authenticated pursuant to this disclosure in order to ensure the legitimacy of its source, confirm its ownership, and even further restrict access to it to licensed users. To that end, in some embodiments, a digital asset may be stored on a distributed ledger configured to immutably record data characterizing the ownership and source of such digital asset. For example, users of the first computing device 302 and the user electronic device 304 may be users of at least one distributed ledger 308, known to those skilled in the art. For instance, as noted above, the distributed ledger 308 may comprise a peer-to-peer network, a cloud-based computing network, a fog computing network, a blockcloud computing network, or another blockchain-configured database known in the art capable of secure or unsecure data transfer. In some embodiments, the distributed ledger 308 may be facilitated by a website that may require a registration and login prior to use. Moreover, the distributed ledger 308 may be substituted for any distributed ledger known to those skilled in the art.

In one embodiment, a data record may be stored in multiple copies across the distributed ledger 308 on one or more nodes. While not separately pictured, any of one or more of the first computing device 302 or the user electronic device 304 may serve as one or more nodes. In some embodiments, each node may contain and run the software, hardware, firmware, or any other component, necessary to run the present invention. More specifically, each node may provide for a computer system that may run the program of the present invention, create, store, and link (or “chain”) data records to other data records. Each node may also provide for computational power sufficient to perform hash functions, other one-way encryption functions, two-way encryption functions, public key encryption functions and programs, symmetric encryption and symmetric key encryption functions and programs, along with any other function that may be used or provided for by the present invention.

In brief, the original or “genesis” data record may comprise, at least, a hash that records a timestamp representing the data record's creation date and time (along with, in some embodiments, other information), encrypted user-specific data, and instructions for the linking of the second data record to the present data record. In some embodiments, the instructions may comprise a mathematical problem to be solved. In some embodiments, the present invention may provide that the solution is provided to one or more nodes in the distributed ledger 308. In some embodiments, some or all of the nodes in the distributed ledger 308 may be equally able to solve the instructions, and therefore some or all of the nodes may discover the solution at roughly the same time, thus ensuring uniformity of record-keeping across blockchain-configured database 308. Additional data records may be linked to the genesis data record, and may comprise a new timestamp hash unique to that data record, the previous data record's hash, encrypted updated user-specific data, and instructions for the next block as detailed elsewhere herein.

The distributed ledger 308 may also be configured to associate a data record, and user-specific data within the data record, with a digital asset distributer identifier. For example, the distributer identifier may be a QR code. In some embodiments, the distributer identifier may be stored and displayed on the first computing device 302 or another computing device. The distributer identifier may be scanned by another computing device, such as the user electronic device 304 configured to work with the present invention. In such a configuration, the distributer identifier may be used as a digital asset distributer's private key and may, when scanned, cause the present invention to unlock, decrypt, or otherwise permit access to one or more items of user-specific data. As a non-limiting, clarifying example, a digital asset may be a restricted-access performer costume digitally rendered and configured to digitally overlay a performer real-world costume configured as a physical asset within this disclosure at an authorized user electronic device 304 display. The restricted-access performer costume may be only viewable to a limited number authorized of users. Such users may be given access to the exemplary restricted-access performer costume by way of a distributer (or owner, or licensor) QR code printed, for instance, on a ticket stub or performance program, and scannable by the user electronic device 304. Scanning such code may effectively unlock, decrypt, or otherwise permit access to the authorized, scanning user.

The distributed ledger may also be operative to generate and link a distributer identifier to at least one authorized viewer.

The distributed ledger 308 may be further operative to generate at least one distributer digital wallet and at least one viewer digital wallet. In these embodiments, the at least one distributer wallet may be associated with the at least one digital asset owner or licensor and the at least one viewer digital wallet may be associated with the authorized viewer of such digital asset. In the event that the digital asset is a non-fungible token, the distributed ledger 308 may be operative to distribute or transfer a digital asset identifier from the at least one distributer digital wallet to the at least one viewer digital wallet.

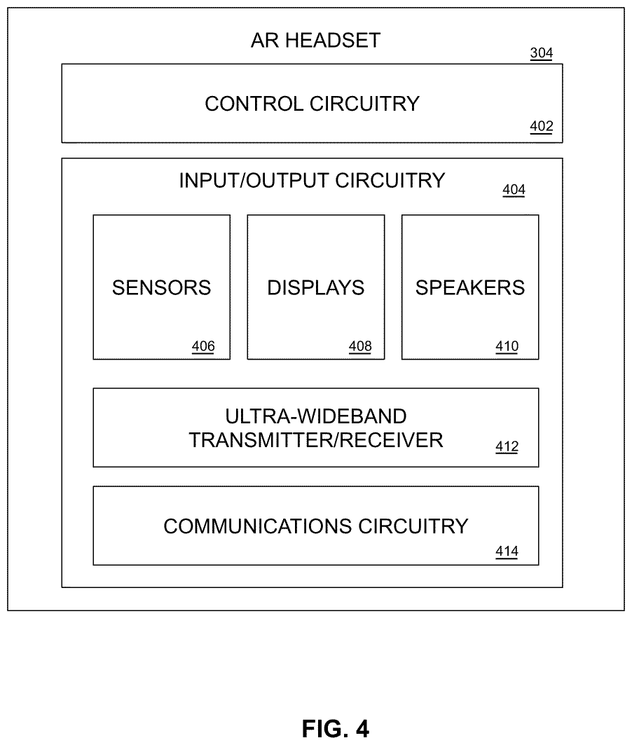

FIG. 4 illustrates an exemplary user electronic device, which may be the user electronic device 304 of FIG. 3 as augmented reality headset or glasses. Of course, this is offered by way of example only, and not limitation. As noted above, the user electronic device may be embodied as any computing device, for example and without limitation, a mobile computing device such as a smartphone or tablet computer that incorporate cellular telephone functionality, or a laptop computer or desktop computer as well. In some embodiments, the user electronic device may be equipped with a camera comprising a lens, however, it will be understood that the present invention operates without reliance on any camera whether present in a device or not.

In one embodiment, the augmented reality headset 304 has control circuitry 402 configured to synthesize information from input/output including sensors 406, such as motion sensors, and other input/output circuitry 404 operative to determine the location and orientation of a physical asset relative to the user electronic device 304. In some embodiments, the user electronic device 304 sensors 406 comprise motion sensor circuitry that gathers motion sensor data that enables the user electronic device 304 to accurately display a digital asset, overlaid on the physical asset, according to the real-world position and location of the physical asset relative to the user electronic device 304. Determining the position of the physical asset relative to the user electronic device 304 may be based at least partly on the communications signals exchanged between the respective user electronic device and physical asset transmitters and receivers, such as ultra-wideband transmitter/receivers 412.

The user electronic device 304 may comprise a display 408 mounted, for example, in a housing. In the case of a augmented reality headset, the housing may be configured to appear similar to glasses frames and be further configured to handlessly maintain the display 408 in front of a user's eyes. In the interest of clarity, the input/output circuitry 402 will enable the user electronic device 304 to perceptibly change the perspective of the digital asset on or around the physical asset on its display 408 in response to communications signals exchanged via the ultra-wideband transmitter/receiver 412 from the physical asset that indicates a change in the position and orientation of the physical asset relative to each of any number of user electronic devices.

In some embodiments, the user electronic device 304 may further comprise speakers 410 configured to output sounds perceptible to the user.

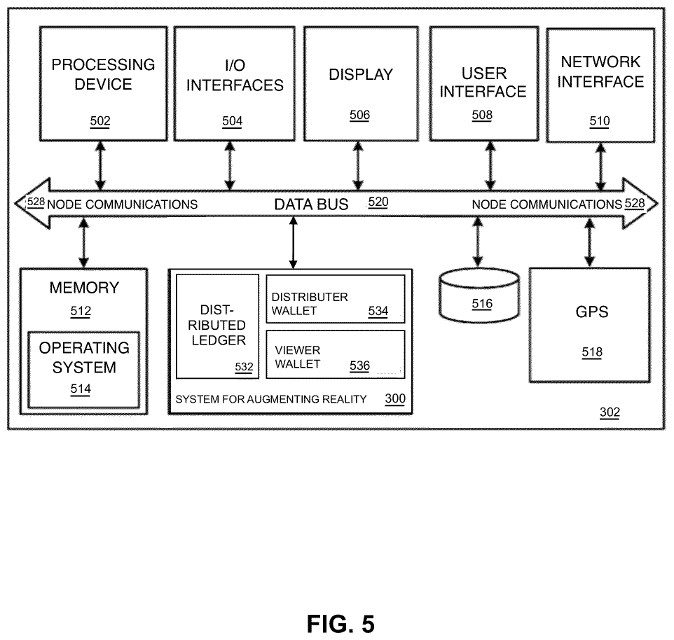

Communications circuitry 414 may enable communications between the user electronic device 304 and distributer computing device as well. FIG. 5 shows a block diagram of an exemplary first computing device 302 as a distributer electronic device. Such electronic device may be configured to serve as a node 501 in the system for augmenting reality 300. The node 501 may comprise, at least, its own control circuitry used to run software on the device, including a processing device (processor) 502 and storage or memory 512. In addition, the node 501 may comprise at least one input/output interface 504, at least one display 506, at least one user interface 508, at least one network interface 510, at least one operating system 514, at least one mass storage 516, and even, as the case may be, at least one GPS 518, with each communicating across a local data bus 520. FIG. 5 also discloses the relationship of local data bus 520, the distributed ledger 308 (or, collectively “data blocks”), the at least one distributer digital wallet 522, and the at least one viewer digital wallet 524 of the system for augmenting reality 300. In some embodiments, node 501 may communicate with other node(s) 528 via one or more networks (not shown in FIG. 5). Additionally, the digital asset identifier (not pictured) may act as a private key that may enable one or more nodes 501 to access blockchain-encrypted data in an unencrypted or deidentified, or both, form.

As the present invention contemplated a distributed ledger computer system wherein each node 501 may communicate with one or more nodes 501, and in some embodiments, all other nodes 501, one or more elements of node 201 may be absent in any particular node 201 or shared across one or more nodes 501. In some embodiments, while it is contemplated that, generally although not required in every case, each node 501 may store a copy of all digital asset data blocks 232 and their block-chains across the entire present invention, thereby creating a network of secure computing systems and thorough redundancy, one or more other elements may be partially stored on one or more nodes 501, or stored on one node 501 but accessed by another node 501. By way of illustration and not limitation, memory 512 and/or operating system 514 may be partially stored across several nodes 501 but accessed by multiple nodes 501, or may be stored on one or more nodes 501 and accessed by nodes 501 that do not have their own memory 512 and/or operating system 514.

The control circuitry, or processing device 502 may include any custom made or commercially available processor, a central processing unit (CPU) or an auxiliary processor among several processors associated with node 501, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory 512 may include any one of a combination of volatile memory elements (e.g., random-access memory (RAM, such as DRAM, and SRAM, etc.)) and nonvolatile memory elements. The memory typically comprises native operating system 514, one or more native applications, emulation systems, or emulated applications for any of a variety of operating systems and/or emulated hardware platforms, emulated operating systems, etc. For example, the applications may include application specific software which may comprise some or all the components of node 201. In accordance with such embodiments, the components are stored in memory and executed by the processing device. Note that although depicted separately in FIG. 5, the system, method, and apparatus for augmenting reality 300 may be resident in memory such as memory 512. As mentioned above, in some embodiments, one or more nodes 501 may not have their own memory 512 and/or operating system 514 or may store incomplete memory 512 and/or operating system 514, and may therefore draw upon other nodes 501 for use of one or more memory units 512 and/or operating system elements 514 via node 501 to node 501 communication 528, as discussed herein.

User interface 508 may be configured to detect contact within the display area of the display 506 and may provide such functionality as on-screen buttons, menus, keyboards, etc. that allows users to navigate user interfaces by touch. User interface 508 may also be a keyboard, a mouse, a microphone, a vision tracking system, a motion-capture system, a trackball, or any other known interface with a computing system. For some embodiments, node 501 may also comprise GPS 518 or other means to determine the location of the node 501.

One of ordinary skill in the art will appreciate that the operating system 514 can, and typically will, comprise other components which have been omitted for purposes of brevity. Note that in the context of this disclosure, a non-transitory computer-readable medium stores one or more programs for use by or in connection with an instruction execution system, apparatus, or device. With further reference to FIG. 5, network interface device 510 comprises various components used to transmit and/or receive data over a networked environment such as depicted in FIG. 3. When such components are embodied as an application, the one or more components may be stored on a non-transitory computer-readable medium and executed by the processing device.

In some embodiments, data blocks stored on the distributed ledger 532 may be stored in one language, generally the user's native language. In some embodiments, however, the present invention may provide, through memory 512 or any other element of the present invention including elements known to the art but not disclosed in FIG. 5, that the data blocks on the distributed ledger 532 may be translated into a selected language by an end user. For example, the present invention may provide that data blocks on the distributed ledger 532 may be stored in English, but when accessed by a user, by using one or more of user electronic device(s) 304 to access data blocks via QR code, the data blocks may be translated into the language of the accessing device, here computing device(s) 302 of FIG. 3. This change may be automated in some embodiments, and may enable users to globally review and appreciate data blocks authenticating their transactions.

Storage information for the exemplary blockchain elements of the present invention, which may encompass all the data for the present invention, as discussed in more detail herein, is generally managed as a series of links or “chains” between blocks, wherein each link to the chain requires a mathematical problem to be solved. Once a node 501 has reached the solution, the next block may be linked or chained to the present cryptocurrency data blocks block 532, thus creating the “blockchain” known in the art. In such embodiments, the distributed ledger may be operative to chain a first new ownership data block to a previous ownership data block. The first new ownership data block may correspond to the transfer of the digital asset to the at least one viewer digital wallet. Such chaining may comprise, in some embodiments, recording the hash of a first cryptocurrency data blocks 532 in or on a second cryptocurrency data blocks 532. In some embodiments, therefore, the chain may be traced by examining the corresponding hashes of each cryptocurrency data blocks 532 to make sure that they match as intended.

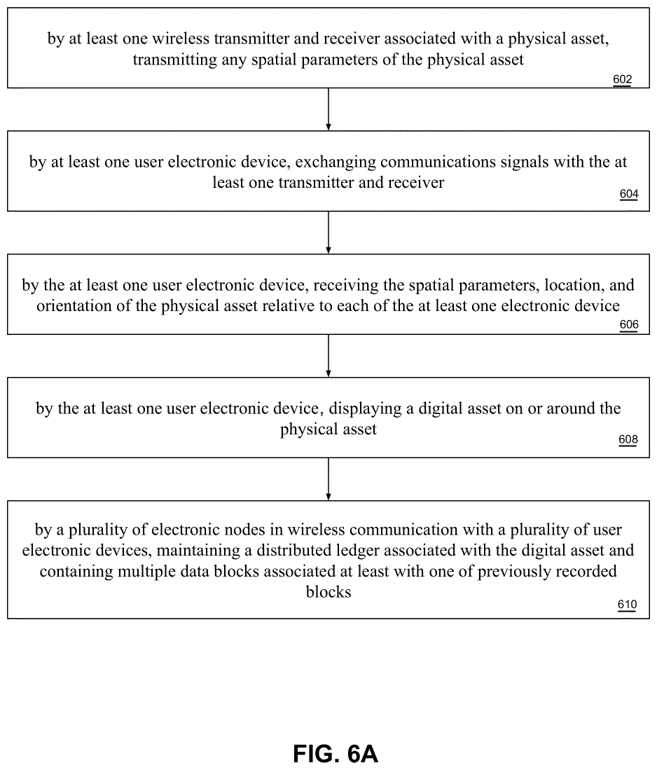

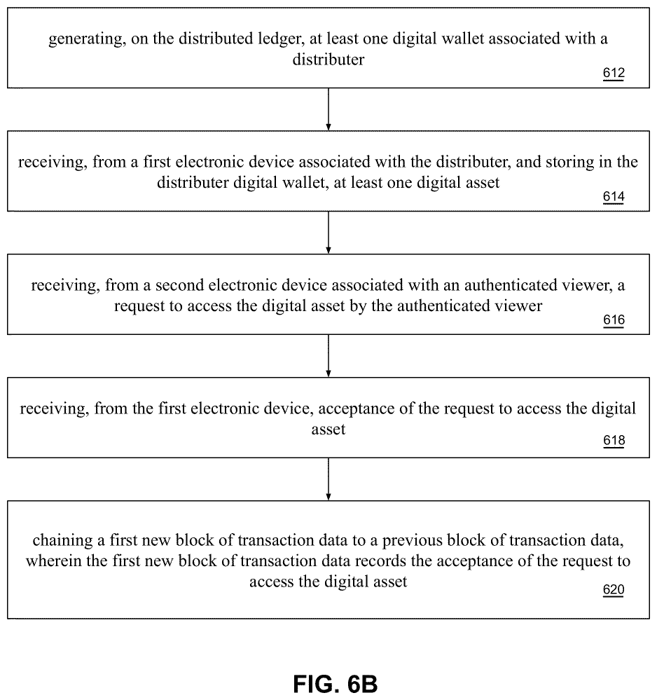

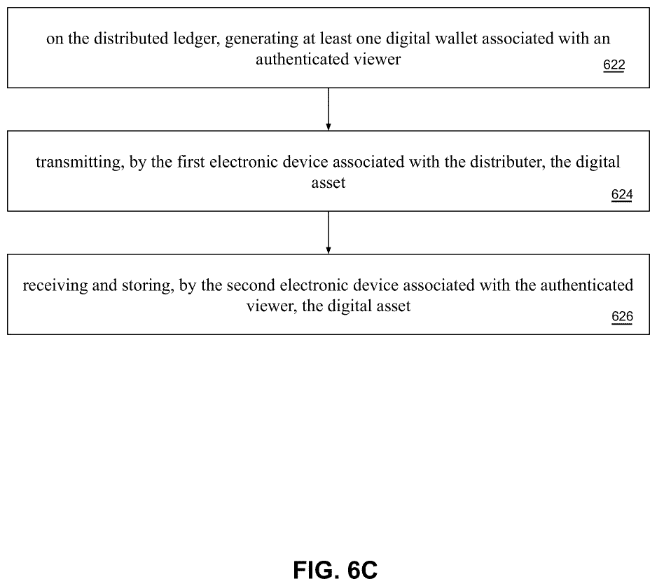

FIGS. 6A-C are a series of flowcharts depicting an exemplary embodiment of a method for augmenting reality with authenticated, digital assets via predefined physical assets, such as may be performed by the electronic devices 302, 304, and physical asset 306 of FIG. 3. As shown in FIG. 6A, the method includes the steps of: by at least one wireless transmitter and receiver associated with a physical asset, transmitting any spatial parameters of the physical asset (block 602); and by at least one user electronic device comprising control circuitry and a display, exchanging communications signals with the at least one transmitter and receiver (block 604), receiving the spatial parameters, location, and orientation of the physical asset relative to each of the at least one user electronic device (block 606), and displaying a digital asset on or around the physical asset (block 608); and by a plurality of electronic nodes in wireless communication with a plurality of user electronic devices, maintaining a distributed ledger associated with the digital asset and containing multiple data blocks associated at least with one of previously recorded blocks (block 610).

In an embodiment, and pursuant to the detailed description above, the control circuitry may be configured to change the perspective of the digital asset on or around the physical asset on each user electronic device display in response to communications signals from the physical asset that indicates a change in the spatial parameters, location, and orientation of the physical asset relative to each user electronic device.

With respect to authentication of the digital assets themselves and authorization to access such digital assets, the method, as shown in FIG. 6B may further comprise: generating, on the distributed ledger, at least one digital wallet associated with a distributer (block 612); receiving, from a first electronic device associated with the distributer, and storing in the distributer digital wallet, at least one digital asset (block 614); receiving, from a second electronic device associated with an authenticated viewer, a request to access the digital asset by the authenticated viewer (block 616); receiving, from the first electronic device, acceptance of the request to access the digital asset (block 618); chaining a first new block of transaction data to a previous block of transaction data, wherein the first new block of transaction data records the acceptance of the request to access the digital asset (block 620).

Such method may further comprise, in accordance with the exemplary embodiment of FIG. 6C on the distributed ledger, generating at least one digital wallet associated with an authenticated viewer (block 622); transmitting, by the first electronic device associated with the distributer, the digital asset (block 624); and receiving and storing, by the second electronic device associated with the authenticated viewer, the digital asset (block 626).

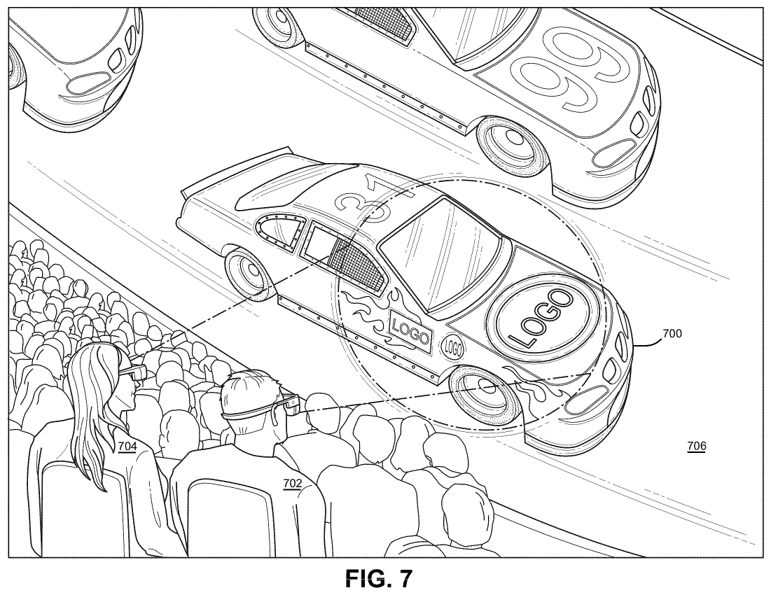

Yet another exemplary embodiment of the system, in use, is provided as a clarifying yet non-limiting example of the system and method for augmenting reality with authenticated, digital assets, via predefined, physical assets. In FIG. 7, a vehicle 700 at a sponsored race may be a targeted physical asset comprising one or more ultra-wideband chips. Though the chips are obscured from view in the figure, one of ordinary skill in the art will recognize that they may be affixed in any manner as desired or necessary to the vehicle 700, such as by gluing or welding, without departing from the invention. Two viewers, 702, 704 are shown wearing an augmented reality headset equipped with a chip operative to communicate with the chip of the physical asset. Such headsets comprise a display and control circuitry configured to realistically change the perspective of any digital asset-here the exemplary LOGOs-on or around the physical asset on each electronic device display in response to communications signals from the physical asset that would indicates a change in the spatial parameters, location, and orientation of the physical asset relative to each of the plurality of user augmented reality headsets. Thus, in this example, as the vehicle 700 traverses the racetrack 706, the apparent size, shape, location, and orientation of the LOGOs relative to each individual viewer 702, 704 will change. Indeed, relative to each individual viewer 702, 704 augmented reality headsets, as user electronic devices, any digital assets overlayed on the vehicle 700 would accurately appear to be applied to the surface of vehicle 700 as well as accurately traverse the racetrack 706 as well.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. That is, the type, quality, quantity, appearance, or the like of physical and digital assets will not be limited by the disclosure. Likewise, the system and method may be employed in innumerable settings. For example, authenticated digital assets may be associated with the electronic device of—and thus assigned to—specified ticket holders at particular live performances or events to exclusively enhance such ticket holders' experiences; authenticated digital assets may be deployed for advertising purposes; and authenticated digital assets may even be deployed as a commemorative token. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the system and method for augmenting reality with authenticated, digital assets via predefined, physical assets with which that terminology is associated. In general, the terms used in the following claims should not be constructed to limit the system and method for augmenting reality with authenticated, digital assets via predefined, physical assets to the specific embodiments disclosed in the specification unless the above description section explicitly define such terms. Accordingly, the actual scope encompasses not only the disclosed embodiments, but also all equivalent ways of practicing or implementing the disclosed system and method. The above description of embodiments of the system and method for augmenting reality with authenticated, digital assets via predefined, physical assets is not intended to be exhaustive or limited to the precise form disclosed above or to a particular field of usage.

While specific embodiments of, and examples for, the method and system are described above for illustrative purposes, various equivalent modifications are possible for which those skilled in the relevant art will recognize.

While certain aspects of the method and system disclosed are presented below in particular claim forms, various aspects of the method and system are contemplated in any number of claim forms. Thus, the inventor reserves the right to add additional claims after filing the application to pursue such additional claim forms for other aspects of the system and method for augmenting reality with authenticated, digital assets via predefined, physical assets.

What is claimed is:

1. A system for augmenting pre-defined physical assets with digital assets without the use of a camera, comprising:
at least one physical asset comprising at least one wireless transmitter and corresponding receiver operative to transmit any spatial parameters of the physical asset; and
a plurality of user electronic devices, each comprising control circuitry and a display, such electronic device operative to:
a) exchange communications signals with the at least one transmitter and receiver of the physical asset;
b) determine the spatial parameters, location, and orientation of the physical asset relative to each of the plurality of user electronic devices; and
c) display a digital asset on or around the physical asset; and
a plurality of electronic nodes in wireless communication with the plurality of user electronic devices, the plurality of electronic nodes configured to maintain a distributed ledger associated with the digital asset and containing multiple data blocks associated at least with one of previously recorded blocks;
wherein the control circuitry is configured to change the perspective of the digital asset on or around the physical asset on each electronic device display in response to communications signals from the physical asset that indicates a change in the spatial parameters, location, and orientation of the physical asset relative to each of the plurality of user electronic devices.

2. The system of claim 1, wherein the communications signals are ultra-wideband communications signals.

3. The system of claim 1, wherein the electronic device comprises motion sensor circuitry that gathers motion sensor data, and
wherein determining the location and orientation of the physical asset relative to the electronic device based at least partly on the exchanged communications signals comprises determining the location and orientation of the physical asset relative to the electronic device.

4. The system of claim 1, wherein the electronic device is operative to overlay and display the digital asset onto the physical asset.

5. The system of claim 1, wherein the distributed ledger is a blockchain.

6. The system of claim 1, wherein the electronic device is an augmented reality headset.

7. The system of claim 1, further comprising:
on the distributed ledger, at least one digital wallet associated with a distributer;
a first electronic device associated with the distributer, operative to store, in the distributer digital wallet, and transmit at least one digital asset;
a second electronic device associated with an authenticated viewer, operative to transmit a request to access the digital asset by the authenticated viewer;
wherein, responsive to receiving the request to access the digital asset from the first electronic device, the first electronic device associated with the distributer is operative to accept the request to access the digital asset; and
wherein responsive to accepting the request to access the digital asset from the first electronic device, chaining a first new block of transaction data to a previous block of transaction data, wherein the first new block of transaction data records the acceptance of the request to access the digital asset.

8. The system of claim 7, wherein the distributed ledger comprises at least one digital wallet associated with an authenticated viewer;
wherein the first electronic device associated with the distributer is operative to transmit the digital asset to the second electronic device associated with the authenticated viewer;
wherein the second electronic device associated with the authenticated viewer is operative to receive and store the digital asset; and
wherein the digital asset is a non-fungible token.

9. A method for augmenting pre-defined physical assets with digital assets without the use of a camera, comprising:
by at least one wireless transmitter and receiver associated with a physical asset, transmitting any spatial parameters of the physical asset; and
by at least one electronic device comprising control circuitry and a display:
a) exchanging communications signals with the at least one transmitter and receiver;
b) receiving the spatial parameters, location, and orientation of the physical asset relative to each of the at least one electronic device; and
c) displaying a digital asset on or around the physical asset; and
by a plurality of electronic nodes in wireless communication with a plurality of user electronic devices, maintaining a distributed ledger associated with the digital asset and containing multiple data blocks associated at least with one of previously recorded blocks;
wherein the control circuitry is configured to change the perspective of the digital asset on or around the physical asset on each electronic device display in response to communications signals from the physical asset that indicates a change in the spatial parameters, location, and orientation of the physical asset relative to each electronic device.

10. The method of claim 9, wherein the communications signals are ultra-wideband communications signals.

11. The method of claim 9, wherein the electronic device comprises motion sensor circuitry that gathers motion sensor data, and
wherein determining the location and orientation of the physical asset relative to the electronic device based at least partly on the exchanged communications signals comprises determining the location and orientation of the physical asset relative to the electronic device.

12. The method of claim 9, wherein the electronic device is operative to overlay and display the digital asset onto the physical asset.

13. The method of claim 9, wherein the distributed ledger is a blockchain.

14. The method of claim 9, wherein the electronic device is an augmented reality headset.

15. The of method of claim 9, further comprising:
generating, on the distributed ledger, at least one digital wallet associated with a distributer;
receiving, from a first electronic device associated with the distributer, and storing in the distributer digital wallet, at least one digital asset;
receiving, from a second electronic device associated with an authenticated viewer, a request to access the digital asset by the authenticated viewer;
receiving, from the first electronic device, acceptance of the request to access the digital asset;
chaining a first new block of transaction data to a previous block of transaction data, wherein the first new block of transaction data records the acceptance of the request to access the digital asset.

16. The method of claim 15, wherein the second electronic device is an augmented reality headset.

17. The method of claim 15, further comprising
generating, on the distributed ledger, at least one digital wallet associated with an authenticated viewer;
transmitting, by the first electronic device associated with the distributer, the digital asset; and
receiving and storing, by the second electronic device associated with the authenticated viewer, the digital asset;
wherein the digital asset is a non-fungible token.

18. A non-transitory, tangible computer-readable medium having stored thereon computer-executable instructions, which, when executed by a computer processor, enable performance of a method comprising:
by at least one wireless transmitter and receiver associated with a physical asset, transmitting any spatial parameters of the physical asset; and
by at least one electronic device comprising control circuitry and a display:
a) exchanging communications signals with the at least one transmitter and receiver;
b) receiving the spatial parameters, location and orientation of the physical asset relative to each of the at least one electronic device; and
c) displaying a digital asset on or around the physical asset; and
by a plurality of electronic nodes in wireless communication with a plurality of user electronic devices, maintaining a distributed ledger associated with the digital asset and containing multiple data blocks associated at least with one of previously recorded blocks;
wherein the control circuitry is configured to change the perspective of the digital asset on or around the physical asset on each electronic device display in response to communications signals from the physical asset that indicates a change in the spatial parameters, location, and orientation of the physical asset relative to each electronic device.
